(19) United States
(12) Patent Application Publication
(10) Pub. No.: US 2004/0004812 A1
(43) Pub. Date: Jan. 8, 2004

(54) Pivotable processor shroud and method of use

(75) Inventors: James D. Curlee, Round Rock, TX (US); Daniel S. Carr, Round Rock, TX (US); Ty R. Schmitt, Round Rock, TX (US); Raul Cortes, Pflugerville, TX (US)

Correspondence Address: BAKER BOTTS, LLP, 910 LOUISIANA, HOUSTON, TX, 77002-4995, US

(73) Assignee: Dell Products L.P., Round Rock, TX

(21) Appl. No.: 10/188,914

(22) Filed: Jul. 3, 2002

(51) Int. Cl. G06F 1/20; F24H 3/02

(52) U.S. Cl. 361/687; 361/695; 165/80.3; 165/121; 415/177

(57) ABSTRACT

An information handling system includes a chassis with a vent area, a fan mount and a shroud. The fan mount is secured to the chassis such that the rear opening of the fan mount is adjacent to the vent area of the chassis. The shroud is pivotally attached to the fan mount and is selectively movable between a first position and a second position. The first position allows the shroud to communicate the vent area with a selected portion of the interior of the chassis. The second position provides access to the selected portion of the interior of the chassis.

### TECHNICAL FIELD

The following disclosure is related in general to electronic systems and more particularly to a rotating processor shroud and method of manufacturing a computer system using a rotating processor shroud.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store and communicate information and may include one or more computer systems, data storage systems, and networking systems.

Processors and other components used in information handling systems require active cooling systems with complex air ducts or shrouds to direct air flow across the processors. Active cooling systems remove heat generated within the system and thereby prevent the system from over heating. Air ducts or shrouds are typically used to direct the flow of air, typically pulled from a fan component, across selected areas within the chassis of the information system such as the area which holds the system's processor. The manufacturing of these complex air ducts often requires expensive tooling, long tooling lead times, and complex manufacturing assembly. For instance, some previously developed shrouds are single complex parts requiring complex injection molded tooling. These parts are complex due, in part, to the mass of the part required to retain fan components during shipping. In other systems, multiple shrouds are required to properly cool multiple processors disposed in multiple locations.

The size and complexity of the shroud usually prevents integrating the shroud in the computer chassis prior to the final assembly of the information handling system because the shroud blocks access to the interior of the chassis where the assembly operation takes place. Accordingly, shrouds are typically shipped separate from the chassis for assembly. The separate shipment of the shroud introduces additional costs. For instance, the shroud must be shipped and received separately from the chassis and the installation of the shroud within the chassis contributes to manufacturing time, reducing the overall factory throughput.

### SUMMARY

Therefore, a need has arisen for a processor shroud that does not require separate shipment from the system chassis.

Also, a need has arisen for a processor shroud that facilitates access to the interior of the system chassis.

A further need has arisen for a processor shroud that increases factory throughput.

In accordance with teachings of the present disclosure, a system and method are described for a pivotable processor shroud and method of use that substantially reduces or eliminates the problems associated with existing processor shrouds.

In one aspect, an information handling system is described that includes a chassis with a vent area, a fan mount and a shroud. The fan mount is secured to the chassis such that the rear opening of the fan mount is adjacent to the vent area of the chassis. The shroud is pivotally attached to the fan mount and selectively movable between a first position and a second position. The first position allows the shroud to communicate the vent area with a selected portion of the interior of the chassis. The second position provides access to the selected portion of the interior of the chassis. More particularly, the selected portion of the interior of the chassis may house a circuit board and at least one processor.

In another aspect, the present disclosure teaches a method for cooling a processor. The method includes securing a fan mount adjacent to a vent portion of computer system chassis. A shroud is then pivotally attached to the fan mount such that the shroud may pivot between a first position and a second position. The shroud may be positioned in the first position, adjacent a selected area of the computer chassis. The shroud may also be positioned in the second position to provide access to a selected area within the computer system chassis.

The present disclosure includes a number of important technical advantages. One important technical advantage is providing a shroud that can pivot between a first position and a second position. The pivotable shroud facilitates access to the interior of the computer system chassis while the shroud is installed. This allows the shroud to be assembled within the chassis prior to assembly of the computer system, decreasing the number of assembly steps and thereby increasing factory throughput. Further technical advantages are described in the description, figures, and claims.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1A is a depiction of a portion of a computer system chassis broken away with a rotating processor shroud in a first position in accordance with teachings of the present disclosure;

FIG. 1B is a depiction of a computer system chassis with a rotating processor shroud in a second position;

FIG. 1C is an exploded view of a processor shroud assembly including a fan mount, a fan, and a shroud according to teachings of the present disclosure;

FIG. 2A is an overhead view of a dual-fan processor shroud in a first position in accordance with the present disclosure;

FIG. 2B is an overhead view of a dual-fan processor shroud in a second position;

FIG. 2C is a depiction of a dual-fan processor shroud assembly; and

FIG. 3 is a flow diagram of a method of using a rotating processor shroud in accordance with the present disclosure.

### DETAILED DESCRIPTION

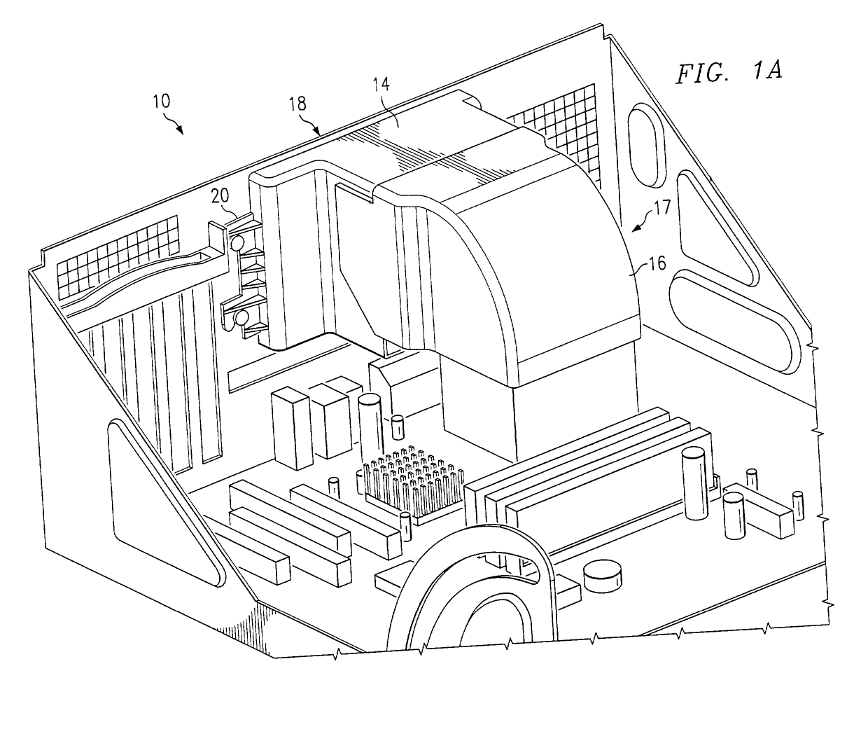

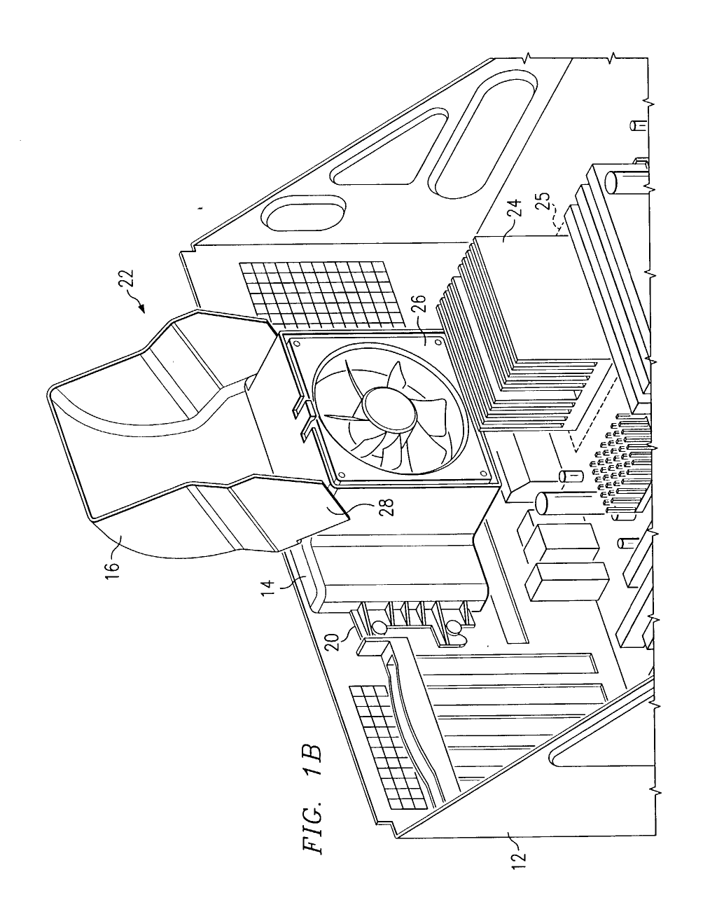

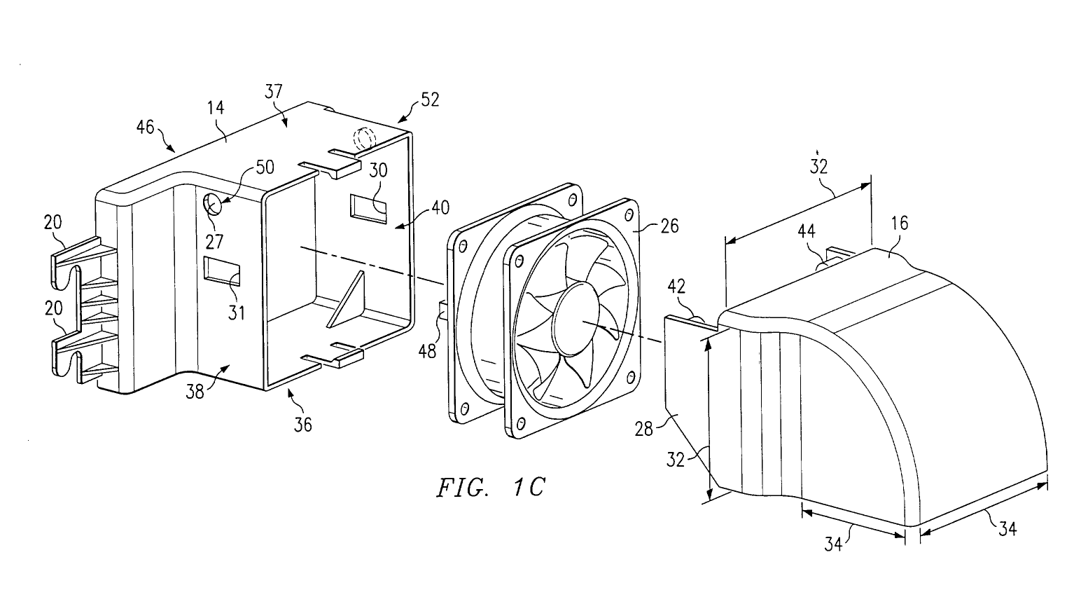

Preferred embodiments and their advantages are best understood by reference to FIGS. 1 through 3, wherein like numbers are used to indicate like and corresponding parts.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1A, a depiction of a broken away computer system chassis with a rotating processor shroud is shown. A computer system or information handling system is depicted generally at 10 and includes a housing or chassis 12 and a rotating processor shroud. The rotating processor shroud includes fan mount 14 and shroud 16. Shroud 16 may also be referred to as a hood. Chassis 12 includes vent area 18 formed within a side of chassis 12 to permit air to flow from the interior portion of chassis 12 to the exterior portion of chassis 12 or vice versa. In the present embodiment, fan mount 14 is secured to chassis 12 adjacent to vent area 18. Shroud 16 is pivotally and releasably secured to fan mount 14 such that shroud 16 is movable between a first position 17 as shown and a second position 22 as shown in FIG. 1B.

Chassis 12 includes an interior portion wherein information handling system components such as circuit boards, microprocessors, memory components such as hard drives, floppy drives, CD drives, sound cards, peripheral components and other components may be installed. Chassis 12 also preferably includes a cover component which is not expressly shown, but when attached to chassis 12 effectively encloses the interior of chassis 12.

Now referring to FIG. 1B, a depiction of a computer system chassis with a rotating processor shroud in a second position is shown. Second position 22 allows access to the interior of chassis 12. In the present preferred embodiment, second position 22 of shroud 16 provides access to processor housing portion 25. Accordingly, when shroud 16 is placed in first position 17 as shown in FIG. 1A shroud 16 directs air flow between vent area 18 and selected housing portion 25. Selected processor housing portion 25, presently shown with a dashed line, is the area in which microprocessors are attached to the circuit board. In an alternative embodiment, the selected processor housing portion 25 may be in a different position of the interior of the housing, dictated by a change in computer system configuration. In another alternative embodiment, a computer system may house multiple processors and may have multiple selected processor housing portions.

In the present embodiment, fan component 26 is disposed within fan mount 14. Fan mount 14 and shroud 16 are connected via shroud interface 28. Shroud interface 28 preferably allows shroud 16 to pivot or rotate with respect to fan mount 14 such that shroud 16 may rotate between first position 17 as shown in FIG. 1A and second position 22. Also shown in the present embodiment, processors 24 are mounted adjacent to selected processor housing portion 25. Positioning shroud 16 in second position 22 preferably provides access to selected processor housing portion 25 and processor 24. Positioning shroud 16 in first position 17 directs air flow from fan 26 to processors 24.

Now referring to FIG. 1C, an exploded view of a processor shroud assembly is shown. Fan mount component includes bottom 36 and top 37 which are joined together by first side 38 and second side 40. Fan mount 14 also includes mounting interface 20.

In the present embodiment, mounting interface 20 includes mounting tabs which are preferably formed to interface with portions of chassis 12. In the present preferred embodiment mounting tabs 20 are formed to allow simplified, tool-less attachment to and removal from chassis 12. In an alternative embodiment mounting interface 20 may include any suitable fastener or attachment technique such as using loose fasteners. The present embodiment allows fan mount 14 to be releasably secured adjacent to chassis 12 such that rear opening 46 of fan mount 14 is adjacent to or is abutting vent area 18. Bottom 36, top 37, and sides 38 and 40 are formed to communicate rear opening 46 to front opening 48.

Fan mount 14 also includes fan retainer tab 30. Fan retainer tab 30 facilitates the selectively releasable disposal of fan component 26 within the interior of fan mount 14. Fan 26 is preferably sized to fit within the interior space formed by bottom 36, top 37 and sides 38 and 40. Disposing fan 26, which is typically a relatively heavy component within the system, within fan mount 14, a static portion of the shroud assembly, provides for advantageous shock and vibration characteristics.

Fan mount 14 also includes first aperture 50 and second aperture 52 formed within first side 38 and second side 40, respectively. Apertures 50 and 52 are formed to receive pivot nubs 42 and 44 described below. First side 38 and second side 40 also have apertures 31 formed therein. Apertures 31 are formed to interface with a portion of shroud 16 to operatively retain shroud 16 in first position 17. The portion of shroud 16 may be an indentation formed to be received by aperture 31, a tab, or any suitable device for interfacing with aperture 31.

In the present embodiment fan 26 comprises a so-called hot plug redundant fan such as a standard 92 millimeter fan. However, in an alternative embodiment, fan 26 may be any fan component suitable for moving air from the interior of chassis 12 to the exterior of chassis 12 vice versa.

Shroud component 16 is preferably formed to communicate front opening 48 of fan mount with a desired location within the interior of chassis 12. Shroud 16 includes a first opening defined by edges 32 and a second opening defined by edges 34. When shroud 16 is positioned in first position 17 as shown in FIG. 1 first opening 32 communicates front opening 48 of fan mount 14 with the second opening 34 of shroud 16. Shroud 16 further includes first pivot nub 42 and second pivot nub 44 formed to interface with mounting interface 27 of fan mount 14. More specifically, first pivot nub 42 is formed to interface with first aperture 50 of fan mount 14 and second pivot nub 44 is formed to interface with second aperture 52 on fan mount 14. First pivot nub 42 and second pivot nub 44 are preferably formed to allow shroud 16 to move from first position 17 to second position 22. In an alternative embodiment, shroud 16 and mount 14 may pivotally interface using any suitable means.

In another alternative embodiment, mount 14 may have an opening within top 37 or may have removed top 37 altogether. The removal of top 37 may facilitate installing fan 26 from above. In an alternative embodiment, a second shroud or replacement shroud may be provided to replace shroud 16. This replacement shroud (not expressly shown) may be formed to interface with fan mount 14, similar to shroud 16, and to move between a first position and a second position. However, a replacement shroud may be formed such that the second opening of the replacement shroud will be placed adjacent to an alternative selected portion of chassis 12 than selected processor housing portion 25 of the present embodiment. This allows for processor shroud 16 to be easily and conveniently replaced in the event that the information handling system or computer system is changed and the area within the interior of housing 12 that requires cooling is changed. Additionally, this allows standardized fan mount component to be utilized with specialized shroud components formed to direct air flow to a specific area with the interior of chassis 12.

Allowing shroud 16 to be positioned in second position 22 allows assembly, maintenance and repair operations to be streamlined significantly. Because selected processor housing portion 25 may be accessed after the shroud assembly is installed, the shroud assembly (fan mount 14, shroud 16, and fan 26) may be installed within chassis 12 prior to the final assembly. This aspect is advantageously reduces shipping cost by reducing the number of shipments required and the amount of space required for shipping. Additionally, when the shroud assembly is installed within the chassis prior to shipment for final assembly/manufacturing, the final assembly and manufacturing process is streamlined, because the step of installing the shroud assembly is eliminated. Yet another advantage is that the multiple component shroud assembly is often easier to assemble within the confined space of chassis 12 than a rigid shroud.

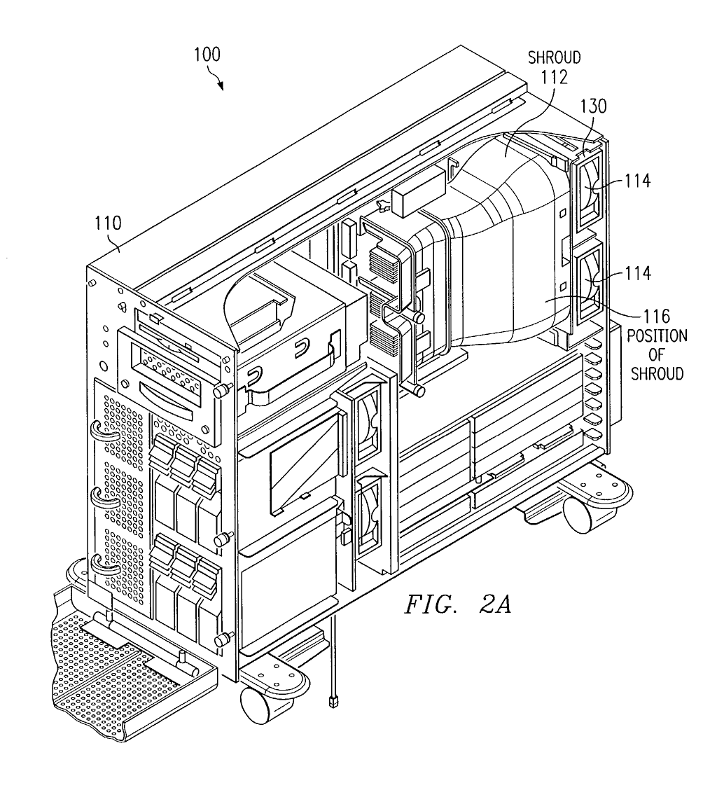

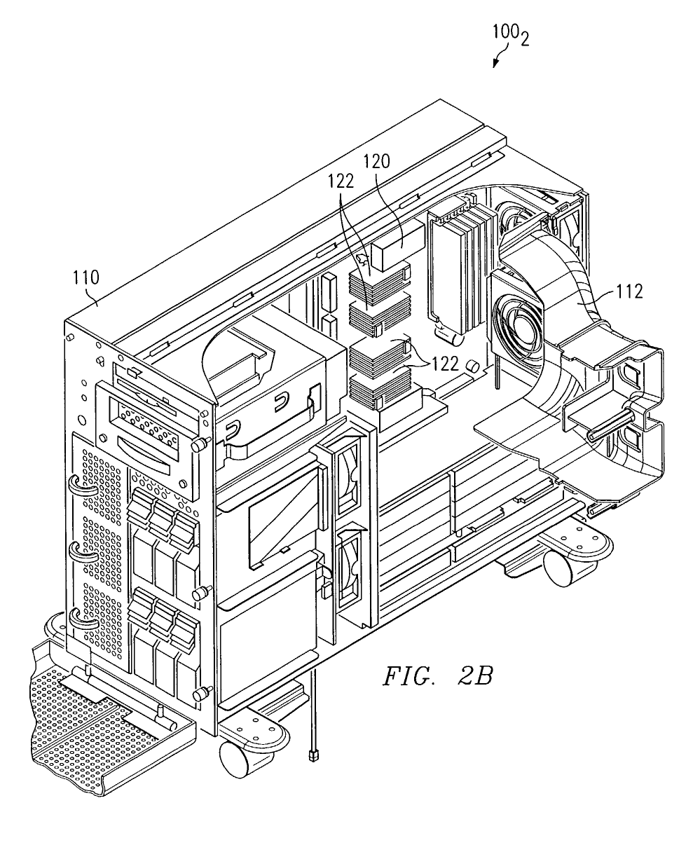

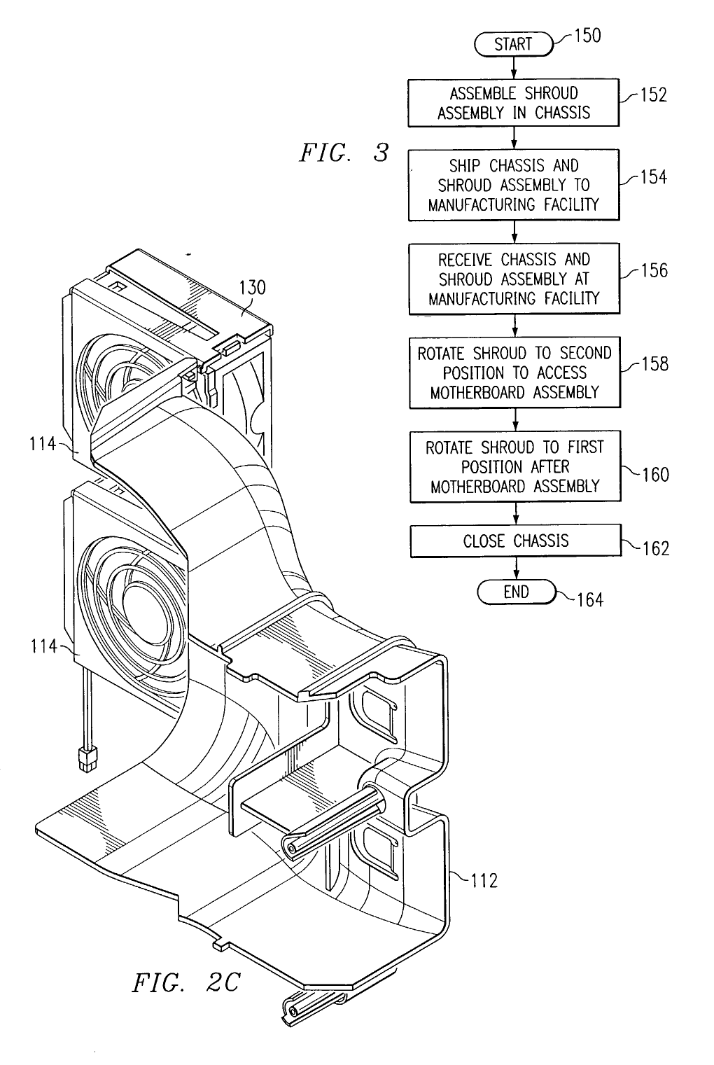

Now referring to FIG. 2A, an overhead view of a computer system with a dual fan processor shroud is shown. Computer system 100, sometimes referred to as an information handling system, includes chassis 110 and a variety of components disposed therein. Computer system 100 may be utilized, for example, in a rack or tower orientation. System 100 also includes shroud 112 in first position 116. Shroud 112 is disposed adjacent to fan mount 130, holding fans 114. The mounting of fan mount 130 to chassis 110 and shroud 116 to fan mount 130 are similar to those shown in FIGS. 1A-1C.

FIG. 2B shows shroud 112 in second position 118 allowing access to selected processor housing area 120. Selected processor housing area 120 preferably includes the area for housing processors 122. When shroud 112 is in second position 118, selected processor housing area 120 may be physically accessed for assembly inspection maintenance and repair activities.

In first position 116, shroud 112 facilitates the communication of air across processors 122. Fans 114 operate to draw air across processors 112 or push air across processors 122 to maintain processors 112 at a desired temperature. In the present embodiment, shroud 112 facilitates the cooling of multiple processor. Further FIG. 2C depicts fan mount 130 attached to chassis 110.

In for certain configurations of system 100, it may be desirable to reduce the airflow to certain areas, such as when a computer system which is compatible to house processors in multiple areas but is configured to house one or more processors in a single area. In such situations, a so-called “closeout” component (not expressly shown) may be disposed within shroud 112. The closeout component is preferably positioned within the shroud between the area where airflow will be reduced and fans 114. The closeout acts to block airflow to area. The closeout may be removably secured within shroud 112 using tabs or other tool-less means or with loose fasteners.

Now referring to FIG. 3, a flow diagram of a method according to the present disclosure. The method begins 150 with the assembly of a shroud assembly within a chassis 152. This step typically includes first disposing a fan mount component adjacent to a vent area of a chassis. A fan may then be secured in the fan mount and the shroud or hood component is then pivotally mounted to the fan mount. Next, the chassis and shroud assembly are shipped together a manufacturing facility 154 where they are received 156. During assembly, the shroud is rotated to the second position to access the motherboard 158. After assembly within the interior of the chassis is complete, the processor shroud is rotated to the first position 160. The chassis is then closed 162 and the assembly process is completed 164.

Although the disclosed embodiments have been described in detail, it should be understood that various changes, substitutions and alterations can be made to the embodiments without departing from their spirit and scope.

What is claimed is:

1. An information handling system comprising:
a chassis having at least one vent area formed to facilitate air flow therethrough;
a fan mount secured to the chassis, the fan mount having a front opening and a rear opening, the rear opening disposed adjacent to the vent area;
the fan mount further comprising a shroud interface;
a shroud formed to communicate the first opening with a selected processor housing portion of the chassis interior, the shroud pivotally attached to the shroud interface and selectively movable between a first position operable to communicate the first opening and the processor housing portion and a second position operable to allow access to the selected processor housing portion.

2. The information handling system of claim 1 further comprising the chassis having an area for securing a circuit board and at least one processor corresponding to the selected processor housing portion.

3. The information handling system of claim 1 further comprising the fan mount formed to receive a fan component.

4. The information handling system of claim 1 further comprising the fan mount formed to receive a first fan and a second fan.

5. The information handling system of claim 1 further comprising a second shroud operable to attach to the shroud interface and operable to communicate the first opening with a second processor housing portion of the chassis and a second position operable to allow access to the second processor housing portion.

6. The information handling system of claim 1 further comprising the shroud operable to communicate the first opening and at least two processor housing portions.

7. The information handling system of claim 1 wherein the fan mount further comprises at least one fan retainer operable to releasably secure a fan within the fan mount.

8. The information handling system of claim 1 further comprising the shroud formed using an injection molding technique.

9. The information handling system of claim 1 wherein the fan mount further comprises at least one mounting tab operable to selectively secure the fan mount to the chassis.

10. The information handling system of claim 1 wherein the shroud interface further comprises a first aperture formed within a first side of the fan mount and a second aperture formed within a second side of the fan mount; and
the shroud further comprises a first pivot nub and a second pivot nub formed to pivotally engage the first aperture and second aperture, respectively.

11. The information handling system of claim 1 further comprising the shroud having a latch assembly operable to releasably secure the shroud in the first position.

12. The information handling system of claim 1 wherein the fan mount further comprises a bottom, a first side, a second side, and a top.

13. A pivotable processor shroud assembly comprising:
a fan mount operable to selectively attach to a chassis, the fan mount having a front opening in communication with a rear opening;
a shroud pivotally attached to the fan mount, the shroud operable to pivot between a first position and a second position, the first position operable to communicate the fan mount rear opening and a selected interior portion of the chassis, the second position operable to facilitate access to the selected interior portion.

14. The processor shroud of claim 13 wherein the selected interior portion of the chassis further comprises at least one processor.

15. The pivotable processor shroud of claim 13 further comprising the fan mount operable to selectively house a fan component.

16. The processor shroud of claim 13 further comprises a first pivot nub and a second pivot nub formed to interface with the fan mount and allow the shroud to pivot between the first position and the second position.

17. The processor shroud of claim 13 further comprising a closeout component disposed within the shroud.

18. A method for cooling a processor comprising:
securing a fan mount adjacent to a vent portion of computer system chassis;
pivotally attaching a shroud to the fan mount, the shroud operable to pivot between a first position and a second position;
positioning the shroud in the second position to provide access to a selected area within the computer system chassis, the selected area housing at least one processor; and
positioning the shroud in the first position adjacent the selected area.

19. The method of claim 18 further comprising disposing a fan component within the fan mount.

20. The method of claim 18 further comprising releasably securing the shroud in the first position.
